(19) United States
(12) Patent Application Publication
(10) Pub. No.: US 2002/0154765 A1
(43) Pub. Date: Oct. 24, 2002

(54) Mobile communication terminal

(75) Inventors: Shigeru Suzuki, Niiza-shi (JP); Ryosuke Kasaya, Sagamihara-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/106,507

(22) Filed: Mar. 27, 2002

(30) Foreign Application Priority Data
Mar. 27, 2001 (JP) 2001-090063

(51) Int. Cl. H04M 9/00

(52) U.S. Cl. 379/433.01

(57) ABSTRACT

A mobile communication terminal comprises a first case and a second case. Electronic components to be contained in the upper and lower cases are fixed to the lower case by means of an inner case. The upper and lower cases are coupled by engagement of claw portions. The inner case and the upper case are firmly coupled by a screw engagement structure, which ensures less easily releasable engagement than the engagement by claw portions. Thereby, even in the state in which the upper case is removed, internal components in the terminal can be protected as surely as possible.

### CROSS-REFERENCE TO RELATED APPLICATIONS

This application is based upon and claims the benefit of priority from the prior Japanese Patent Application No. 2001-090063, filed Mar. 27, 2001, the entire contents of which are incorporated herein by reference.

### BACKGROUND OF THE INVENTION

1. Field of the Invention

The present invention relates to an improvement of the structure of a mobile communication terminal.

2. Description of the Related Art

A mobile communication terminal has a structure wherein a wiring board and electronic components mounted on the wiring board are received in a housing which comprises an upper case and a lower case. In some modern mobile communication terminals, an upper case on which user's input buttons are provided is structured to be easily separable from a lower case, so that the upper case may easily be replaced with some other upper case with a design that the user likes.

In the conventional structure, however, if the upper case is separated from the lower case, the internal components of the terminal and the wiring board on which these components are mounted are exposed. Consequently, foreign matter such as dust may enter and causes short-circuit of the wiring pattern, thus preventing normal operations of the terminal.

As has been described above, in the conventional mobile communication terminal so structured to permit the user to relatively easily separate the upper case from the lower case for replacement of the upper case, there is a danger that foreign matter may enter the terminal and cause malfunction.

### BRIEF SUMMARY OF THE INVENTION

The object of the present invention is to provide a mobile communication terminal with such a structure that the upper case can easily be replaced and the internal components can be protected as surely as possibly.

According to the present invention, there is provided a mobile communication terminal comprising:

a printed wiring board unit having a key plate with stationary contacts and a dome portion with movable contacts;

a key pad provided with a plurality of keys configured to push the movable contacts of the dome portion toward the stationary contact portions of the key plate; and

a lower case on which the printed wiring board unit and the key pad are mounted;

an inner case mounted on the printed wiring board unit and the key pad;

fitting members configured to fit the inner case, the printed wiring board and the key pad on the lower case;

an upper case removably mounted on the inner case, the lower and upper cases constituting a terminal housing configured to receive the inner case, the printed wiring board unit and the key pad, one of the lower and upper cases being provided with one of a movable claw portion and a stationary claw portion, other of the lower and upper cases being provided with the other of the movable claw portion and the stationary claw portion, and the movable claw portion being removably engaged with the stationary claw portion to fix the second case to the first case.

According to the present invention, there is also provided a mobile communication terminal comprising:

a printed wiring board unit having a key plate with stationary contacts and a dome portion with movable contacts;

a key pad having a unitary structure, mounted on the printed wiring board and provided with a plurality of keys configured to push the movable contacts of the dome portion toward the stationary contact portions of the key plate;

a terminal housing including first and second cases, configured to receive the printed wiring board unit and key pad;

an inner case interposed between the first case, and the key pad and the printed wiring board unit in the housing, and;

screws configured to fit the inner case, the printed wiring board and the key pad on the lower case;

the first case being removably mounted on the inner case, one of the first and second cases being provided with one of a movable claw portion and a stationary claw portion, other of the first and second cases being provided with the other of the movable claw portion and the stationary claw portion, and the movable claw portion being removably engaged with the stationary claw portion to fix the second case to the first case.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exploded perspective view schematically showing a mobile communication terminal according to an embodiment of the present invention;

FIG. 2 is a schematic cross-sectional view of the mobile communication terminal, taken along line II-II in FIG. 1;

FIG. 3 is a schematic cross-sectional view of the mobile communication terminal, taken along line III-III in FIG. 1;

FIG. 4 is a schematic cross-sectional view of the mobile communication terminal, taken along line IV-IV in FIG. 1; and

FIG. 5 is a schematic cross-sectional view taken along line V-V in FIG. 1, showing the state in which the upper case is removed from the lower case in the mobile communication terminal shown in FIG. 1.

### DETAILED DESCRIPTION OF THE INVENTION

A mobile communication terminal according to an embodiment of the present invention will now be described with reference to the accompanying drawings.

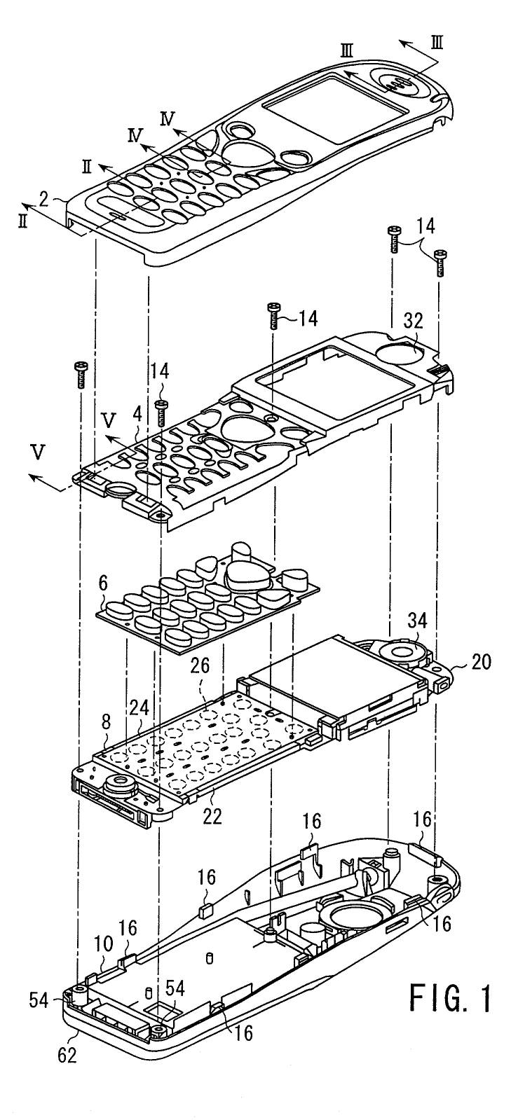

FIG. 1 is an exploded perspective view of a mobile communication terminal according to an embodiment of the present invention. The terminal, as shown in FIG. 1, comprises an upper case 2, an inner case 4, a key pad 6, a printed wiring board unit 8, and a lower case 10. The key pad 6 is disposed on the printed wiring board unit 8, and the inner case 4 is mounted on the key pad 6 and the printed wiring board unit 8. The inner case 4 is fixed to the lower case 10 with the printed wiring board unit 8 interposed between the inner case and the lower case and the key pad 6 also interposed between the printed wiring board 8 and the inner case 4. Thus, the inner case 4, key pad 6 and printed wiring board unit 8 are fixed to the lower case 10.

The key pad 6 is provided with numeral keys and character keys 6A, and the upper case 2 has key holes 2A corresponding to the numeral keys and character keys 6A. The numeral keys and character keys 6A are inserted into and arranged in the key holes 2A, respectively, when the upper case 2 is fixed on the lower case 10. Thus, the numeral keys and character keys 6A can be pushed by user.

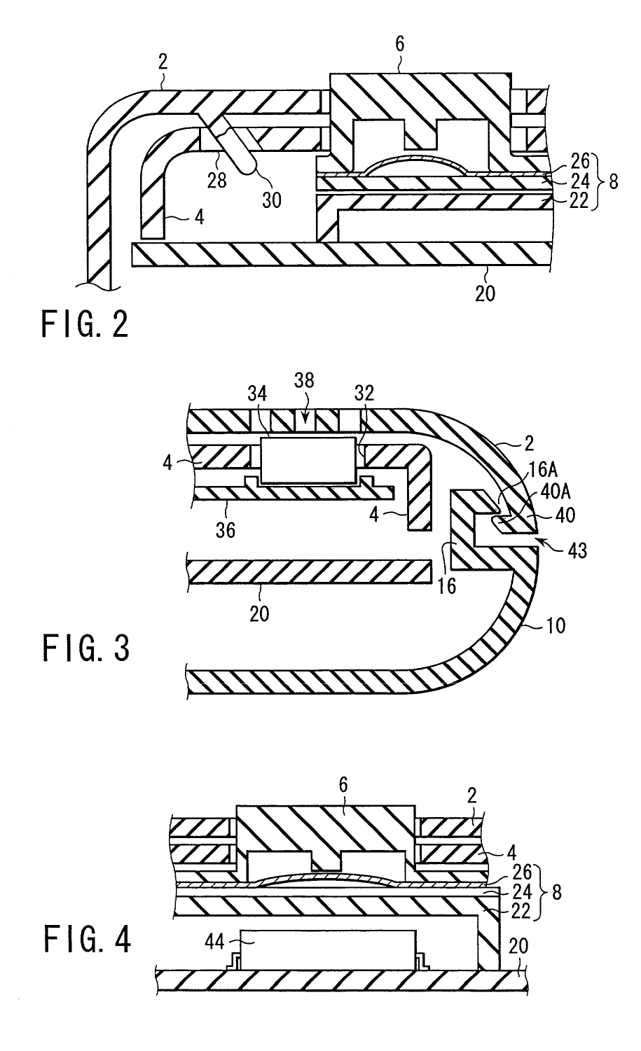

In this configuration, stationary claw portions (not shown in FIG. 1) of the upper case 2 are engaged with movable claw portions 16 provided on the lower case 10. Thereby, the upper case 2 and lower case 10 are fixedly coupled. The assembled state of the terminal, in which all parts are fixed, will now be described with reference to cross-sectional views of FIGS. 2-4, which are taken along lines II-II, III-III and IV-IV in FIG. 1, respectively.

FIG. 2 is a cross-sectional view taken along line II-II in FIG. 1. The printed wiring board unit 8 comprises a main board 20, a shield case 22 mounted on the main board 20, a key plate 24 provided on the shield case 22 and a dome portion 26 mounted on the key plate 24. Stationary contacts are printed on the key plate 24, and movable contacts are provided on the inner portion of the dome portion 26. The stationary contacts and the movable contacts are separated each other, when no depression force is applied to the key pad 6. The key pad 6 is depressed to deform the dome portion 26 and make contact between the movable contacts and the stationary contacts.

The inner case 4 has a recess 28 and the upper case 2 has a projection 30, at the one side of the terminal, as shown in FIG. 2. The projection 30 of the upper case 2 is inserted in the recess 28 so that the projection 30 is engaged with recess part of the inner case 4, the recess part defining the recess 28. In this state, the upper case 2 and lower case 10 are also engaged by claws at the opposite side of the terminal, as illustrated in FIG. 3. FIG. 3 is a cross-sectional view taken along line III-III in FIG. 1.

Furthermore, the inner case 4 is provided with a hole portion 32 at the other side of the terminal, the hole portion 32 defining a receiver hole in which a receiver 34 is fitted. The receiver 34 is fixed on a receiver holder 36 and the receiver 34 faces a hole section 38 of the upper case 2 and produces a reception call sound.

The upper case 2 has a stationary claw portion 40 at a distal end portion thereof, the stationary claw portion 40 being bent into the inward of the case 2. The lower case 10 has a flexible claw portion 16 formed in L-shaped section, which can be deformed into the inner space of the terminal. The length of a cantilever of the movable claw portion 16 is determined such that when the upper case 2 is pushed onto the lower case 10, a distal end portion of the movable claw portion 16 is pressed by the stationary claw portion 40 and bent inward of the terminal. If the upper case 2 is further pushed onto the lower case 10, the stationary claw portion 40 engages the movable claw portion 16. As a result, the upper case 2 is attached to the lower case 10.

The distal end portion of the movable claw portion 16 is provided with a chamfered portion 16A, and also the stationary claw portion 40 is provided with a chamfered portion 40A. By virtue of this structure, the engagement between the movable claw portion 16 and stationary claw portion 40 can be released by general users, other than service engineers, by inserting and driving a relatively hard plate-like thing such as a coin in a gap 43 created at an engagement region of the movable claw portion and stationary claw portion of the upper case 2 and lower case 10 in the coupled state.

Movable claw portions 16 provided on side edge portions of the lower case 10 shown in FIG. 1 are engaged with stationary claw portions provided at those portions of the upper case 2, which correspond in position to the movable claw portions 16. When the upper case 2 is to be removed from the lower case 10, the movable claw portion 16 and stationary claw portion 40 shown in FIG. 3 are first disengaged and then the movable claw portions at the side edges of the lower case 10 are disengaged from the stationary claw portions of the upper case 2 successively from the upper side to lower side of the upper case 2.

FIG. 4 is a cross-sectional view taken along line IV-IV in FIG. 1. FIG. 4 illustrates the state in which an electronic component 44 mounted on the main board 20 is shielded by the shield case 22. The other structural elements have already been described with reference to FIG. 2, and so a description thereof is omitted.

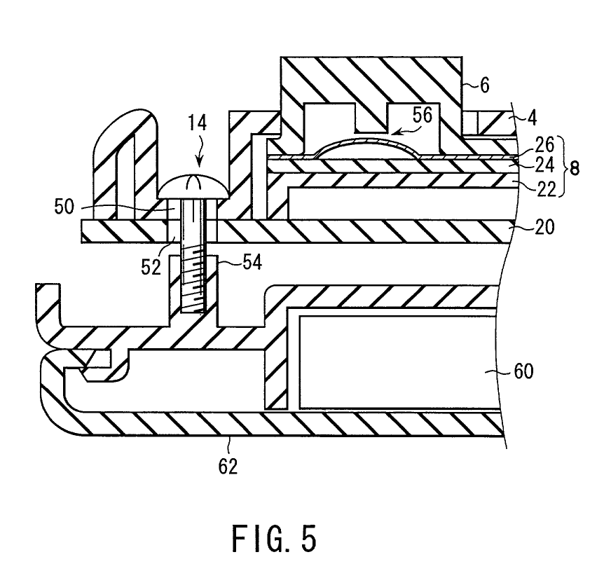

Referring to FIG. 5, a description will now be given of the state in which the upper case 2 is removed from the lower case 10. FIG. 5 is a cross-sectional view taken along line V-V in FIG. 1. A screw 14 is driven in a female screw 54 provided on the lower case 10 through a hole portion in the inner case 4 and a hole portion 52 in the main board 20. Five screws 14 are shown in FIG. 1. If a special screw, such as one for a receiver, which cannot be fastened or loosened by means of an ordinary driver, is used as at least one of the screws 14, the inner case 4 will not easily be removed by general users.

The inner case 4 is thus fixed to the lower case 10. In addition, the key pad 6 and printed wiring board unit 8 are sandwiched between the inner case 4 and lower case 10 and fixed to the lower case 10.

The lower case 10 is provided with a space for receiving a battery pack. A battery pack 60 is mounted in the space. In this state, a cover 62 for the battery pack is attached.

With the above structure, when the upper case 2 is removed from the lower case 10, the inner case 4 is secured to the lower case 10 by means of screws 14, with the key pad 6 and printed wiring board unit 8 sandwiched between the inner case 4 and lower case 10. Accordingly, in the state in which the upper case 2 is removed from the lower case 10, the key pad 6 is held by the inner case 4 and covers the dome portion 26. The dome portion 26 of printed wiring board unit 8 is not exposed. Thus, in the state in which the upper case 2 is removed from the lower case 10, no foreign matter such as dust accumulates on an upper part 56 of the dome portion 26 and the stroke does not vary.

Moreover, the inner case 4 prevents foreign matter from coming to the components or patterns on the main board 20, as well as to the dome portion 26.

Furthermore, when the upper case 2 is to be removed from the lower case 10, a coin is inserted in the gap between the upper and lower cases 2 and 10, and the coin is driven to disengage the movable claw portion 16 and stationary claw portion 40 shown in FIG. 3. Following this, the movable claw portions at the side edges of the lower case 10 are disengaged from the stationary claw portions of the upper case 2 successively from the upper side to lower side of the upper case 2. Thus, a general user, other than a service engineer, can replace the upper case 2, which has been removed, with some other upper case that the user likes. Even when the upper case 2 has been removed from the lower case 10, the inner case 4 is secured to the lower case 10 by means of screws 14. The engagement by the screws is less easily released than that by the claw portions. If the upper case 2 is merely removed, the internal components are not easily exposed, and the internal components and patterns in the terminal can be protected.

In the above-described embodiment, the upper case 2 shown in FIG. 3 is provided with stationary claw portions, and the lower case 10 with movable claw portions. Alternatively, the lower case 10 may be provided with stationary claw portions, and the upper case 2 with movable claw portions.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile communication terminal comprising:
a printed wiring board unit having a key plate with stationary contacts and a dome portion with movable contacts;
a key pad provided with a plurality of keys configured to push the movable contacts of the dome portion toward the stationary contact portions of the key plate; and
a lower case on which the printed wiring board unit and the key pad are mounted;
an inner case mounted on the printed wiring board unit and the key pad;
fitting members configured to fit the inner case, the printed wiring board and the key pad on the lower case;
an upper case removably mounted on the inner case, said lower and upper cases constituting a terminal housing configured to receive the inner case, the printed wiring board unit and the key pad, one of the lower and upper cases being provided with one of a movable claw portion and a stationary claw portion, other of the lower and upper cases being provided with the other of the movable claw portion and the stationary claw portion, and the movable claw portion being removably engaged with the stationary claw portion to fix the second case to the first case.

2. A mobile communication terminal according to claim 1, wherein the upper case is provided with one of a projection and a recess, and the inner case is provided with the other of the projection and recess, the projection being inserted into the recess and the second case being engaged with the inner case.

3. A mobile communication terminal according to claim 1, wherein said upper case has a plurality of key holes and is so mounted on the key pad as to insert the keys in the corresponding through holes.

4. A mobile communication terminal comprising:
a printed wiring board unit having a key plate with stationary contacts and a dome portion with movable contacts;
a key pad having a unitary structure, mounted on the printed wiring board and provided with a plurality of keys configured to push the movable contacts of the dome portion toward the stationary contact portions of the key plate;
a terminal housing including first and second cases, configured to receive the printed wiring board unit and key pad;
an inner case interposed between the first case, and the key pad and the printed wiring board unit in the housing, and;
screws configured to fit the inner case, the printed wiring board and the key pad on the lower case;
the first case being removably mounted on the inner case, one of the first and second cases being provided with one of a movable claw portion and a stationary claw portion, other of the first and second cases being provided with the other of the movable claw portion and the stationary claw portion, and the movable claw portion being removably engaged with the stationary claw portion to fix the second case to the first case.

5. A mobile communication terminal according to claim 1, wherein the first case is provided with one of a projection and a recess, and the inner case is provided with the other of the projection and recess, the projection being inserted into the recess and the first case being engaged with the inner case.

6. A mobile communication terminal according to claim 1, wherein the first case has a plurality of key holes and is so mounted on the inner case as to insert the keys in the corresponding key holes.
